(19) United States
(12) Patent Application Publication
(10) Pub. No.: US 2004/0030071 A1
(43) Pub. Date: Feb. 12, 2004

(54) Method for polymerizing conjugated diolefins (dienes) with catalysts of rare earths in the presence of vinyl aromatic solvents

(76) Inventors: Heike Windisch, Leverkusen (DE); Thomas Schnieder, Lorrach (DE); Gisbert Michels, Leverkusen (DE); Gerd Sylvester, Leverkusen (DE); Pierre Vanhoorne, Dusseldorf (DE); Heinz-Dieter Brandt, Willich (DE); Martina Brandt, Willich (DE); Franziska Hanne Brandt, Willich (DE); Inken Margarethe Brandt, Willich (DE)

Correspondence Address: BAYER POLYMERS LLC, 100 BAYER ROAD, PITTSBURGH, PA, 15205, US

(21) Appl. No.: 10/239,033

(22) PCT Filed: Mar. 12, 2001
(86) PCT No.: PCT/EP01/02730

(30) Foreign Application Priority Data
Mar. 24, 2000 (DE) 100 14 609.0
Jul. 6, 2000 (DE) 100 32 876.8

(51) Int. Cl. C08F 4/44

(52) U.S. Cl. 526/164; 526/335

(57) ABSTRACT

The present invention provides a method for polymerizing conjugated diolefins in the presence of a catalyst of the rare earth metals and in the presence of an aromatic vinyl compound. The diolefins produced thereby may find use in producing rubber-modified molding materials, such as ABS and HIPS.

The present invention relates to a process for the polymerization of conjugated diolefins in the presence of catalysts of the rare earths and in the presence of aromatic vinyl compounds, and the use of these diolefins for the preparation of rubber-modified moulding compositions, in particular of the ABS type and high-impact polystyrene (HIPS).

The polymerization of conjugated diolefins in the presence of a solvent has been known for a long time and is described, for example, by W. Hoffmann, Rubber Technology Handbook, Hanser Publishers (Carl Hanser Verlag) Munich, Vienna, New York, 1989. Thus, for example, polybutadiene is nowadays predominantly prepared by solution polymerization with the aid of coordination catalysts of the Ziegler-Natta type, for example based on compounds of titanium, cobalt, nickel and neodymium, or in the presence of alkyllithium compounds. The particular solvent used depends greatly on the type of catalyst employed. Benzene or toluene and aliphatic or cycloaliphatic hydrocarbons are preferably employed.

A disadvantage of the polymerization processes currently carried out for the preparation of polydiolefms, such as e.g. BR, IR or SBR, is the expensive working up of the polymer solution to isolate the polymers, for example by stripping with steam or direct evaporation. A further disadvantage, especially if the polymerized diolefins are to be further processed as impact modifiers for uses in plastic, is that the polymeric diolefins obtained must first be dissolved again in a new solvent, for example styrene, in order then to be able to be further processed e.g. to acrylonitrilelbutadiene/styrene copolymer (ABS) or high-impact polystyrene (HIPS).

U.S. Pat. No. 3,299,178 claims a catalyst system based on TiCl₄/iodine/Al(iso-Bu)₃ for the polymerization of butadiene in styrene to form homogeneous polybutadiene. The copolymerization of butadiene and styrene using the same catalyst system and the suitability of the catalyst for the preparation of polystyrene are described by Harwart et al. in Plaste und Kautschuk, 24/8 (1977) 540.

U.S. Pat. No. 5,096,970 and EP-A 304 088 describe a process for the preparation of polybutadiene in styrene using catalysts based on neodymium phosphonates, on organic aluminium compounds, such as di(iso-butyl)aluminium hydride (DIBAH), and based on a halogen-containing Lewis acid, such as ethylaluminium sesquichloride, in which butadiene is reacted in styrene without further addition of inert solvents, to give a 1,4-cis-polybutadiene. In the examples described, the polymerization of butadiene is carried out in styrene at 80° C. over a reaction time of up to 6 h, and the butadiene employed is converted in polybutadiene with a conversion of more than 80%. The rubber solutions in styrene described in the patent publications mentioned were employed only for the preparation of high-impact polystyrene (HIPS), the rubber being incorporated in the polystyrene matrix. For this, free radical initiators are added to the rubber solutions in styrene, after removal of the unreacted diolefin.

The possibility of using the rubber solution for the preparation of ABS is not mentioned in EP-A 304 088.

For the preparation of ABS, the rubber is employed in a matrix of acrylonitrile/styrene copolymers (SAN). In contrast to the preparation of HIPS, in the case of ABS the SAN matrix is incompatible with polystyrene. While in the polymerization of diolefins in vinylaromatic solvents polymers of the solvent, such as polystyrene, are also formed in addition to the rubber, in the case of the preparation of ABS the incompatibility of the SAN matrix with the polymerized vinylaromatic leads to a significant deterioration in the material properties of the ABS.

In the case of polymerization of butadiene with catalysts based on transition metal compounds and aluminium-organyls, as described in EP-A 304 088, however, the vinylaromatic solvent, e.g. styrene, is no longer stabilized by the reaction of the stabilizer with the aluminium-organyls employed, so that a high molecular weight polymer of the solvent is formed in a side reaction by a thermally induced free-radical polymerization. The dependence of the rate of styrene polymerization on the temperature and reaction time is known and is described in the literature (see Encycl. Polym. Sci. Eng., vol. 16, 1989).

Under the reaction conditions described in EP-A 304 088, on the other hand, another high molecular weight by-product is formed by a thermally induced free-radical copolymerization of 1,3-butadiene and styrene with a maximum weight content of 10% butadiene, this by-product comprising, on the basis of the copolymerization parameters known in the literature (see Encycl. Polym. Sci., vol. 2, 1985, Polymer Handbook, Third Edition, 1989), a high polystyrene content with a low butadiene content (<20 mol %) and having a glass transition temperature T_{g} of >40° C.

According to EP-A 304 088 the amount of polymerized styrene is up to 1%, based on the amount of monomeric styrene employed, which according to the examples, at a monomer ratio of 90% styrene and 10% butadiene, corresponds to an amount of polymerized styrene of up to 8.2%, based on the polybutadiene formed, even under the ideal pre-requisite of a complete conversion of butadiene to polybutadiene.

In the preparation of ABS this thermoplastic by-product remains in the SAN matrix because of its high molecular weight and functions there as an undesirable crosslinking agent due to the free double bonds of the butadiene content, as a result of which gel and speck formation occurs, which also leads to a significant deterioration in the material properties of the ABS.

The object of the present invention was thus to provide a process for the polymerization of conjugated diolefins in vinylaromatic solvents, with which it is possible to prepare high-cis polybutadiene rubbers, in which the weight content of the by-products formed by free radicals, based on the polydiene rubber, should be <1 wt. %, and the comonomer composition of which should be modified such that the glass transition temperature T_{g} of the polydiene rubber is <0° C.

The present invention therefore provides a process for the polymerization of conjugated diolefins (dienes), which is characterized in that the polymerization of the diolefins is carried out in the presence of catalysts comprising

a) at least one compound of the rare earth metals,

b) at least one organoaluminium compound

c) optionally at least one modifying agent

and in the presence of vinylaromatic compounds at temperatures of −30 to +100° C., wherein the molar ratio of components (a):(b):(c) is in the range from 1:1 to 1,000:0.1 to 10, component (a) of the catalyst is employed in amounts of 10 mmol to 10 mmol per 100 g of the conjugated diolefins employed, and the aromatic vinyl compound is employed in amounts of 50 to 300 parts by wt., preferably 80 to 250 parts by wt. and very particularly preferably 100 to 200 parts by wt. per 100 parts by wt. of the conjugated diolefins employed, and the conversion of diolefin employed is preferably less than 50 mol %, particularly preferably 10 to 45 mol %, very particularly preferably 20 to 40 mol %.

Conjugated diolefins (dienes) which can be employed in the process according to the invention are, for example and preferably, 1,3-butadiene, 1,3-isoprene, 2,3-dimethylbutadiene, 2,4-hexadiene, 1,3-pentadiene and/or 2-methyl-1,3-pentadiene.

Possible compounds of the rare earth metals (component (a)) are, in particular, those chosen from

an alcoholate of the rare earth metals,

a phosphonate, phoshinate and/or phosphate of the rare. earth metals,

a carboxylate of the rare earth metals,

a complex compound of the rare earth metals with diketones and/or

an addition compound of halides of the rare earth metals with an oxygen or nitrogen donor compound.

The abovementioned compounds of the rare earth metals are described in more detail, for example, in EP-A 11 184.

The compounds of the rare earth metals are based in particular on the elements with atomic numbers 21, 39 and 57 to 71. Rare earth metals which are preferably employed are lanthanum, praseodymium or neodymium or a mixture of elements of the rare earth metals which comprises at least one of the elements lanthanum, praseodymium or neodymium to the extent of at least 10 wt. %. Lanthanum or neodymium, which in turn can be mixed with other rare earth metals, are very particularly preferably employed as the rare earth metals. The content of lanthanum and/or neodymium in such a mixture is particularly preferably at least 30 wt. %.

Possible alcoholates, phosphonates, phosphinates and carboxylates of the rare earth metals or complex compounds of the rare earth metals with diketones are, in particular, those in which the organic group contained in the compounds contains, in particular, straight-chain or branched alkyl radicals having 1 to 20 carbon atoms, preferably 1 to 15 carbon atoms, such as, for example and preferably, methyl, ethyl, n-propyl, n-butyl, n-pentyl, isopropyl, isobutyl, tert-butyl, 2-ethylhexyl, neo-pentyl, neo-octyl, neo-decyl or neo-dodecyl.

Alcoholates of the rare earths which are mentioned by way of example and as preferred are: neodymium(III) n-propanolate, neodymium(III) n-butanolate, neodymium(III) n-decanolate, neodymium(III) iso-propanolate, neodymium(III) 2-ethyl-hexanolate, praseodymium(III) n-propanolate, praseodymium(III) n-butanolate, praseodymium(III) n-decanolate, praseodymium(III) iso-propanolate, praseodymium(III) 2-ethyl-hexanolate, lanthanum(III) n-propanolate, lanthanum(III) n-butanolate, lanthanum(III) n-decanolate, lanthanum(III) iso-propanolate and lanthanum(III) 2-ethyl-hexanolate, preferably neodymium(III) n-butanolate, neodymium(III) n-decanolate and neodymium(III) 2-ethyl-hexanolate.

Phosphonates, phosphinates and phosphates of the rare earths which are mentioned by way of example and as preferred are: neodymium(III) dibutylphosphonate, neodymium(III) dipentylphosphonate, neodymium(III) dihexylphosphonate, neodymium(III) diheptylphosphonate, neodymium(III) dioctylphosphonate, neodymium(III) dinonylphosphonate, neodymium(III) didodecylphosphonate, neodymium(III) dibutylphosphinate, neodymium(III) dipentylphosphinate, neodymium(III) dihexylphosphinate, neodymium(III) diheptylphosphinate, neodymium(III) dioctylphosphinate, neodymium(III) dinonylphosphinate, neodymium(III) didodecylphosphinate and neodymium(III) phosphate, preferably neodymium(III) dioctylphosphonate and neodymium(III) dioctylphosphinate.

Carboxylates of the rare earth metals which are suitable are: lanthanum(III) propionate, lanthanum(III) diethylacetate, lanthanum(III) 2-ethylhexanoate, lanthanum(III) stearate, lanthanum(lII) benzoate, lanthanum(III) cyclohexanecarboxylate, lanthanum(III) oleate, lanthanum(III) versatate, lanthanum(III) naphthenate, praseodymium(III) propionate, praseodymium(III) diethylacetate, praseodymium(III) 2-ethylhexanoate, praseodymium(III) stearate, praseodymium(III) benzoate, praseodymium(III) cyclohexanecarboxylate, praseodymium(III) oleate, praseodymium(III) versatate, praseodymium(III) naphthenate, neodymium(III) propionate, neodymium(III) diethylacetate, neodymium(III) 2-ethylhexanoate, neodymium(III) stearate, neodymium(III) benzoate, neodymium(III) cyclohexanecarboxylate, neodymium(III) oleate, neodymium(III) versatate and neodymium(III) naphthenate, preferably neodymium(III) 2-ethylhexanoate, neodymium(III) versatate and neodymium(III) naphthenate. Neodymium versatate is particularly preferred.

Complex compounds of the rare earth metals with diketones which may be mentioned are lanthanum(III) acetylacetonate, praseodymium(III) acetylacetonate and neodymium(III) acetylacetonate, preferably neodymium(III) acetylacetonate.

Addition compounds of halides of the rare earth metals with an oxygen or nitrogen donor compound which are mentioned as examples are: lanthanum(III) chloride with tributyl phosphate, lanthanum(III) chloride with tetrahydrofuran, lanthanum(III) chloride with iso-propanol, lanthanum(III) chloride with pyridine, lanthanum(III) chloride with 2-ethylhexanol, lanthanum(III) chloride with ethanol, praseodymium(III) chloride with tributyl phosphate, praseodymium(III) chloride with tetrahydrofuran, praseodymium(III) chloride with iso-propanol, praseodymium(III) chloride with pyridine, praseodymium(III) chloride with 2-ethylhexanol, praseodymium(III) chloride with ethanol, neodymium(III) chloride with tributyl phosphate, neodymium(III) chloride with tetrahydrofuran, neodymium(I) chloride with iso-propanol, neodymium(III) chloride with pyridine, neodymium(III) chloride with 2-ethylhexanol, neodymium(III) chloride with ethanol, lanthanum(III) bromide with tributyl phosphate, lanthanum(III) bromide with tetrahydrofuran, lanthanum(III) bromide with iso-propanol, lanthanum(III) bromide with pyridine, lanthanum(III) bromide with 2-ethylhexanol, lanthanum(III) bromide with ethanol, praseodymium(III) bromide with tributyl phosphate, praseodymium(III) bromide with tetrahydrofuran, praseodymium(III) bromide with iso-propanol, praseodymium(III) bromide with pyridine, praseodymium(II) bromide with 2-ethylhexanol, praseodymium(III) bromide with ethanol, neodymium(III) bromide with tributyl phosphate, neodymium(III) bromide with tetrahydrofuran, neodymium(III) bromide with iso-propanol, neodymium(III) bromide with pyridine, neodymium(III) bromide with 2-ethylhexanol and neodymium(III) bromide with ethanol, preferably lanthanum(III) chloride with tributyl phosphate, lanthanum(III) chloride with pyridine, lanthanum(IIIl) chloride with 2-ethylhexanol, praseodymium(III) chloride with tributyl phosphate, praseodymium(III) chloride with 2-ethylhexanol, neodymium(III) chloride with tributyl phosphate, neodymium(III) chloride with tetrahydrofuran, neodymium(III) chloride with 2-ethylhexanol, neodymium(III) chloride with pyridine, neodymium(III) chloride with 2-ethylhexanol and neodymium(III) chloride with ethanol.

The rare earth compounds listed in EP-A 727 447 and the rare earth allyl compounds mentioned in WO 96/31544 can also be employed as component a).

Neodymium versatate, neodymium octanoate and/or neodymium naphthenate are very particularly preferably employed as compounds of the rare earth metals.

The compounds of the rare earths can be employed either individually or as a mixture with one another. The particular most favourable mixture ratio can easily be determined by appropriate preliminary experiments.

Those organometallic compounds such as are employed as cocatalysts with Ziegler-Natta catalysts are preferably employed for component b). Compounds of metals from group IIa, IIb and IIIb of the periodic table of the elements may be mentioned as preferred here, particularly preferably magnesium, calcium, boron, aluminium and zinc, very particularly preferably aluminium and magnesium.

The organometallic compounds to be used for component b) are described in detail, for example, in G. Wilkinson, F. G. A. Stone, E. W. Abel, Comprehensive Organometallic Chemistry, Pergamon Press Ltd., New York, 1982, vol. 1 and vol. 3 and in E. W. Abel, F. G. Stone, G. Wilkinson, Comprehensive Organometallic Chemistry, Pergamon Press Ltd., Oxford, 1995, vol. 1 and 2.

Components b), which can in turn be employed individually or as a mixture with one another, which are mentioned as particularly preferred are: dibutylmagnesium, butylethylmagnesium, butyloctylmagnesium, trimethylaluminium, triethyaluminium, tri-n-propylaluminium, tri-iso-proplyaluminium, tri-n-butylaluminium, tri-isobutylaluminium, tripentylaluminium, trihexylaluminium, tricyclohexylaluminium, trioctylaluminium, triethylaluminium hydride, di-n-butylaluminium hydride and di-iso-butylaluminium hydride, ethylaluminium dichloride, diethylaluminium chloride, ethylaluminium sesquichloride, ethylaluminium dibromide, diethylaluminium bromide, ethylaluminium diiodide, diethylaluminium iodide, di-iso-butylaluminium chloride, octylaluminium dichloride and dioctylaluminium chloride, preferably trimethylaluminium, triethylaluminium, tri-iso-butylaluminium and di-iso-butylaluminium hydride.

Alumoxanes can also be employed as component b).

Alumoxanes which are employed are aluminium-oxygen compounds which, as is known to the expert, are obtained by contact between organoaluminium compounds and condensing components, such as e.g. water, and which are non-cyclic or cyclic compounds of the formula (—Al(R)O—)ₙ, wherein the R can be identical or different and represent a linear or branched alkyl group having 1 to 10 carbon atoms, which can also contain heteroatoms, such as e.g. oxygen or nitrogen. In particular, R represents methyl, ethyl, n-propyl, iso-propyl, n-butyl, iso-butyl, tert-butyl, n-octyl or iso-octyl, particularly preferably methyl, ethyl or iso-butyl. Examples of alumoxanes which are mentioned are: methylalumoxane, ethylalumoxane and iso-butylalumoxane, preferably methylalumoxane and iso-butylalumoxane.

Known halogen-containing compounds can be employed as modifying agents (component c) for the Ziegler-Natta catalysts, such as e.g. organic halogen compounds or halogenated inorganic or organometallic compounds of group IIIb, IVb and Vb of the periodic table of the elements.

The following compounds can be employed in particular as component c): methylaluminium dichloride, methylaluminium sesquichloride, dimethylaluminium chloride, methylaluminium dibromide, methylaluminium sesquibromide, dimethylaluminium bromide, ethylaluminium dichloride, ethylaluminium sesquichloride, diethylaluminium chloride, ethylaluminium dibromide, ethylaluminium sesquibromide, diethylaluminium bromide, ethylaluminium diiodide, diethylaluminium iodide, butylaluminium dichloride, butylaluminium sesquichloride, dibutylaluminium chloride, butylaluminium dibromide, butylaluminium sesquibromide, dibutylaluminium bromide, octylaluminium dichloride, dioctylaluminium chloride, dibutyltin dichloride, aluminium tribromide, antimony trichloride, antimony pentachloride, phosphorus trichloride, phosphorus pentachloride, tin tetrachloride, tert-butyl chloride, tert-butyl bromide, tert-butyl iodide, triphenylmethyl chloride, triphenylmethyl bromide and/or triphenylmethyl iodide, particularly preferably ethylaluminium dichloride, ethylaluminium sesquichloride, diethylaluminium chloride, ethylaluminium dibromide, ethylaluminium sesquibromide and/or diethylaluminium bromide.

The organometallic compounds and optionally the modifying agents can be employed either individually or as a mixture with one another. The particular most favourable mixture ratio can easily be determined by appropriate preliminary experiments.

It is also possible to additionally add a further component (d) to the catalyst components (a), (b) and (c). This component (d) can be a conjugated diene which e.g. is the same diene which is to be polymerized later with the catalyst. Butadiene and/or isoprene are preferably used.

If component (d) is added to the catalyst, the amount of (d) is preferably 1 to 1,000 mol per 1 mol of component (d), particularly preferably 1 to 100 mol. 1 to 50 mol of (d) per 1 mol of component (a) are very particularly preferably employed.

The catalysts are employed in the process according to the invention in amounts of preferably 10 μmol to 5 mmol of component (a), particularly preferably 20 μmol to 1 mmol of component (a) per 100 g of the dienes.

It is of course also possible to employ the catalysts in any desired mixture with one another.

The process according to the invention is carried out in the presence of aromatic vinyl compounds, in particular in the presence of styrene, α-methylstyrene, α-methylstyrene dimer, p-methylstyrene, divinylbenzene and/or other alkylstyrenes having 2 to 6 C atoms in the alkyl radical, such as ethylbenzene.

The polymerization according to the invention is very particularly preferably carried out in the presence of styrene, α-methylstyrene, α-methylstyrene dimer and/or p-methylstyrene as the solvent.

The solvents can be employed individually or as a mixture; the most favourable mixture ratio can easily be determined by appropriate preliminary experiments.

The amount of aromatic vinyl compounds employed is preferably 80 to 250 parts by wt., very particularly preferably 100 to 200 parts by wt. per 100 parts by wt. of the diene employed.

The process according to the invention is preferably carried out at temperatures of −20 to 90° C., particularly preferably at temperatures of 20 to 80° C.

In the process according to the invention, the conversion of the conjugated diolefin employed is less than 50 mol %, preferably 10-45 mol %, very particularly preferably 20-40 mol %.

The process according to the invention can be carried out under normal pressure or under increased pressure (0.1 to 12 bar).

The process according to the invention can be carried out continuously or discontinuously, preferably in a continuous procedure.

The solvent used in the process according to the invention does not have to be distilled off but can remain in the reaction mixture. In this manner it is possible, for example if styrene is used as the solvent, for a second polymerization for the styrene to follow, an elastomeric polydiene in a polystyrene matrix being obtained. In an analogous manner, an ethylenically unsaturated nitrile monomer, for example acrylonitrile, can be added to the polydiene solution in styrene before the second polymerization is carried out. ABS is obtained in this manner. Such products are of particular interest as impact-modified thermoplastics.

It is of course also possible to remove some of the solvent employed and/or the unreacted monomers after the polymerization, preferably via a distillation, optionally under reduced pressure, in order to obtain the desired polymer concentration.

It is furthermore possible to add to the polymer solution, before or during the subsequent polymerization of the solvent, which can be carried out in a known manner, e.g. by free-radical or thermal initiation and by known processes of bulk, solution or suspension polymerization in a continuous, semi-continuous or batch procedure, as well as the ethylenically unsaturated nitrile monomers optionally added, such as acrylonitrile, methyl methacrylate, maleic anhydride or maleimide, which can be copolymerized with the vinylaromatic solvent, also additionally the usual aliphatic or aromatic solvents, such as benzene, toluene, dimethylbenzene, ethylbenzene, hexane, heptane or octane, and/or polar solvents, such as ketones, ethers or esters, which are conventionally employed as solvents and/or diluents for the polymerization of the vinylaromatic solvent.

Vinylaromatic monomers which are optionally subjected to free-radical polymerization together with ethylenically unsaturated nitrile monomers and thereby form the homogeneous phase (matrix phase) of the moulding compositions are the same as those which have been employed for the preparation of the rubber solution. Chlorostyrene substituted on the nucleus can furthermore be employed as a mixture with these.

Ethylenically unsaturated nitrile monomers are preferably acrylonitrile and methacrylonitrile, particularly preferably acrylonitrile.

Up to 30 wt. %, preferably up to 20 wt. % of the total monomer amount of acrylic monomers or maleic acid derivatives can furthermore be employed: such as e.g. methyl (meth)acrylate, ethyl (meth)acrylate, tert-butyl (meth)acrylate, esters of fumaric or itaconic acid, maleic anhydride, maleic acid esters, N-substituted maleimides, such as, advantageously, N-cyclohexyl- or N-phenyl-maleimide and N-alkyl-phenyl-maleimide, and also acrylic acid, methacrylic acid, fumaric acid, itaconic acid or amides thereof.

The ratio of vinylaromatic monomers to ethylenically unsaturated nitrile monomers in the ABS moulding compositions is 60-90 wt. % to 40-10 wt. %, based on the matrix phase. The rubber content in the ABS moulding compositions is 5-35 wt. %, preferably 8-25 wt. %, based on the ABS moulding composition. The rubber content in the HIPS moulding compositions according to the invention is 1-25 wt. %, preferably 3-15 wt. %, based on the HIPS moulding composition.

If the free-radical polymerization is carried out in solvents, possible solvents are aromatic hydrocarbons, such as toluene, ethylbenzene and xylenes, and ketones, such as acetone, methyl ethyl ketone, methyl propyl ketones and methyl butyl ketones, and mixtures of these solvents. Ethylbenzene, methyl ethyl ketone and acetone and mixtures thereof are preferred.

The polymerization is advantageously initiated by free radical initiators, but can also be initiated thermally; the molecular weight of the polymer formed can be adjusted by molecular weight regulators.

Suitable initiators for the free-radical polymerization are grafting-active peroxides which dissociate into radicals, such as peroxycarbonates, peroxydicarbonates, diacyl peroxides, perketals or dialkyl peroxides and/or azo compounds or mixtures thereof. Examples are azodiisobutyric acid dinitrile, azoisobutyric acid alkyl esters, tert-butyl perpivalate, tert-butyl peroctoate, tert-butyl perbenzoate, tert-butyl perneodecanoate and tert-butyl per-(2-ethylhexyl)carbonate. These initiators are employed in amounts of 0.005 to 1 wt. %, based on the monomers.

Conventional molecular weight regulators, such as mercaptans and olefins, e.g. tert-dodecylmercaptan, n-dodecylmercaptan, cyclohexene, terpinols and a-methylstyrene dimer, can be employed in amounts of 0.05 to 2 wt. %, based on the monomers, to establish the molecular weights.

The process can be carried out discontinuously, semi-continuously and continuously. In the continuous embodiment, the rubber solution, monomers and optionally solvents can advantageously be polymerized in a continuously charged, thoroughly mixed and stirred tank reactor at a stationary monomer conversion, present after phase inversion, in the first stage of more than 10% and the polymerization initiated by free radicals can be continued in at least one further stage up to a monomer conversion of 30-90%, with thorough mixing in one or more stirred tanks in cascade, which are further continuously operated, or in a plug flow reactor which effects thorough mixing and/or a combination of the two reactor types. Residual monomers and solvent can be removed by conventional techniques (e.g. in heat exchanger evaporators, pressure-release evaporators, extrusion evaporators, thin film or thin layer evaporators, screw evaporators and stirred multi-phase evaporators with kneading and skimming devices), the use of propellants and entraining agents, e.g. water vapour, also being possible, and can be recycled into the process. Additives, stabilizers, anti-ageing agents, fillers and lubricants can be added during the polymerization and during isolation of the polymer.

Discontinuous and semi-continuous polymerization can be carried out in one or more filled or partly filled, thoroughly mixed stirred tanks connected in series, with the rubber solution, monomers and optionally solvents being initially introduced and with polymerization up to the stated monomer conversion of 30-90%.

For better thorough mixing and distribution of the rubber solution fed in, the syrup can be pumped in circulation via organs which effect thorough mixing and shear, both in the continuous and in the discontinuous procedure. Such loop reactors are prior art and can be helpful in establishing the particle size of the rubber. However, the arrangement of shear organs between two separate reactors is more advantageous, in order to avoid backmixing, which leads to a broadening of the particle size distribution.

The moulding compositions according to the invention can be processed as thermoplastics to mouldings by extrusion, injection moulding, calendering, blow moulding, pressing and sintering.

As already mentioned above, the process according to the invention is distinguished by a particularly profitability and a good environmental compatibility, since the solvent used can be polymerized in a subsequent stage, the polymer contained in the solvent serving to modify thermoplastics (e.g. increase the impact strength).

By the process according to the invention it is possible to influence the polymer composition by varying the reaction conditions, such as varying the ratio of diolefins and vinylaromatic solvents employed, the catalyst concentration, the reaction temperature and the reaction time.

Another advantage of the process according to the invention is that with the direct polymerization in styrene it is also possible to prepare and to further process in a simple manner those low molecular weight polymers which, as solids with a high cold flow or high tackiness, can be processed and stored only with difficulty.

The advantage of low molecular weight polymers is that even at a high content of the polymers the solution viscosity remains low, as desired, and the solutions are therefore easy to transport and process.

### EXAMPLES

The polymerization was carried out under argon with exclusion of air and moisture. The isolation, described in individual examples, of the polymers from the solution in styrene was carried out only for the purpose of characterization of the polymers obtained. The polymers can of course also be stored in the solution in styrene and further processed accordingly without being isolated.

The content of styrene in the polymer is determined by means of ¹H-NMR spectroscopy, the selectivity of the polybutadiene (1,4-cis, 1,4-trans and 1,2 content) is determined by means of IR spectroscopy, the solution viscosity is determined in a 5 wt. % solution of the polymer in styrene by means of an Ubelohde viscometer at 25° C., the glass transition temperature T_{g} is determined by means of DSC and the water content is determined by means of Karl-Fischer titration.

The impact strength (aₙ, Izod) was determined at 23° C. and −40° C. in accordance with ISO 180/1 U, and the tensile strength, elongation at break, yield stress and E modulus were determined in accordance with DIN 53 455 and DIN 53 457. The measurement values were determined on injection-moulded shaped articles at a material temperature of 200° C. and a mould temperature of 45° C. The melt volume index (MVI, 220° C., 5 kg) was determined in accordance with DIN 53 735.

### Examples 1 to 7

Catalyst Ageing

33 ml toluene, 6.75 g butadiene, 31.9 ml di-iso-butylaluminium hydride (DIBAH) and 4 ml of a 1 molar ethylaluminium sesquichloride (EASC) solution were added through a septum to 25ml of a 0.245 molar solution of neodymium(III) versatate (NDV) in hexane in a 200 ml Schlenk vessel at 25° C., heated at 50° C. for 2 hours, while stirring, and employed for the polymerization.

Polymerization

The polymerization was carried out in a 40 1 steel reactor with an anchor stirrer (100 rpm). A 1.4 molar solution of DIBAH in hexane was added at room temperature to a solution of butadiene in styrene as a scavenger, the reaction solution was heated to 35° C. in the course of 10 min and the corresponding amount of catalyst solution was added. During the polymerization the reaction temperature was kept at 35° C. After the end of the reaction time the polymer solution was transferred to a second reactor (80 1 reactor, anchor stirrer, 50 rpm) in the course of 5 min and the polymerization was stopped by addition of 345 g acetylacetone with 30.4 g Irganox 1076 and 27 g Irgafos TNPP. To remove unreacted butadiene, the internal pressure of the reactor was reduced at 50° C. to 200 mbar in the course of 1 h and to 100 mbar in the course of 2h.

The batch sizes, reaction conditions and the properties of the polymer obtained are stated in table 1.

TABLE 1

| Example | 1 | 2 | 3 | 4 | 5 | 6 | 7 |
|---|---|---|---|---|---|---|---|
| Catalyst solution in ml | 63.1 | 62 | 68.9 | 68.9 | 68.9 | 69.8 | 69.8 |
| NDV in mmol | 3.6 | 3.6 | 4.0 | 4.0 | 4.0 | 4.0 | 4.0 |
| Polymerization | | | | | | | |
| Styrene in g | 13,504 | 13,500 | 13,500 | 13,500 | 13,500 | 13,500 | 13,500 |
| Water content in ppm | 26 | 17.7 | 15 | 7.7 | 19 | 15 | 14 |
| 1,3-Butadiene in g | 9,003 | 9,000 | 9,000 | 9,000 | 9,000 | 9,000 | 9,000 |
| DIBAH (1.4 molar) in ml | 92.5 | 88.1 | 114 | 90.0 | 82.1 | 115 | 93 |
| Temperature in ° C. | 35 | 35 | 35 | 35 | 35 | 35 | 35 |
| Reaction time in h | 1.4 | 1.5 | 2.0 | 1.27 | 1.5 | 2.0 | 1.4 |
| Polymer | | | | | | | |
| Solids content in wt. % in styrene | 18.26 | 16.62 | 24.9 | 20.3 | 22.0 | 24.9 | 23.0 |
| PS content in the solids content in wt. % | <0.4 | <0.2 | <0.2 | <0.2 | <0.2 | <0.2 | <0.2 |
| cis-BR in % | 97.3 | 97.4 | 96.7 | 97.0 | 97.1 | 96.7 | 97.4 |
| trans-BR in % | 2.3 | 2.0 | 2.9 | 2.6 | 2.3 | 2.9 | 2.0 |
| 1,2-Br in % | 0.4 | 0.6 | 0.4 | 0.4 | 0.6 | 0.4 | 0.6 |
| η (5% in styrene) in mPa · s | 49 | 80 | 42 | 25 | 52 | 42 | 69 |
| Mn in kg/mol | 50 | 46 | n.d. | n.d. | n.d. | n.d. | n.d. |
| Mw in kglmol | 258 | 308 | n.d. | n.d. | n.d. | n.d. | n.d. |

### Example 8

Semi-Continuous ABS Polymerization:

1,200 parts by wt. of the rubber solution from example 3 are mixed together with 1,200 parts by wt. of the rubber solution from example 4, 1,200 parts by wt. of the rubber solution from example 5, 1,308 parts by wt. styrene, 4.8 parts by wt. water and 48 parts by wt. silica gel (Aldrich) and the mixture is filtered at a temperature of 50° C. under a pressure of 2 bar over a 30 μm filter cloth covered with a layer of a further 48 parts by wt. silica gel (Aldrich).

4,355 parts by wt. of the rubber solution obtained after filtration are mixed together with 7.69 parts by wt. p-2,5-di-tert-butylphenol-propionic acid octyl ester (IRGANOX 1076®, Ciba Geigy, Switzerland), 6.92 parts by wt. Irgafos® TNPP (Ciba Geigy, Switzerland), 3,317 parts by wt. styrene and 2,536 parts by wt. acrylonitrile to form a polybutadiene stock solution.

The solution is fed at a rate of 0.686 kg/h into the first reactor, which is stirred with an anchor stirrer at 80 rpm. The reaction temperature is kept at 85° C. under atmospheric pressure. At the same time, 0.7 g tert-butyl perpivalate as a 0.6 per cent solution in methyl ethyl ketone is metered in per hour. The level of fill is kept at 1,387 kg by discharging the polymerization syrup through a bottom outlet (average residence time 1.75 h). After three average residence times a solids content of 30 wt. % is established, corresponding to a conversion of 30%, based on the styrene and acrylonitrile. The operating state is that after phase inversion, and the flow properties of the reaction mixture are more viscous and more elastic than in example 4. No formation of specks is observed.

After a continuous procedure of 31 hours the intake and discharge streams are stopped. In a thoroughly mixed batch reactor, 1,400 g of syrup from the first reaction stage are heated to 85° C. with 5.51 g dimeric α-methylstyrene and 150 g methyl ethyl ketone. A solution of 200 g methyl ethyl ketone and 1.43 g t-butyl perpivalate is then metered in uniformly in the course of 2 h. After the end of the metering the batch is stirred at 85° C. for a further 4 h and then cooled. A solution of 100 g methyl ethyl ketone, 0.1 g 2,5-di-tert-butylphenol, 1.2 g p-2,5-di-tert-butylphenol-propionic acid octyl ester (IRGANOX 1076®, Ciba Geigy, Switzerland) and 8.67 g paraffin oil is then stirred in for stabilization. 1,867 g of an ABS solution with a solids content of 36.0% (52.3% conversion) are obtained.

The reaction mixture is evaporated on a 32 mm laboratory twin-shaft co-rotating screw.

An ABS with 14.3 wt. % polybutadiene, Izod notched impact strength 28.9 kJ/m², shear modulus G′ (corr.) 1,050 MPa and glass transition temperatures of −111° C. for the rubber phase and 104° C. for the SAN phase is obtained.

### Example 9-10

Preparation of HIPS Moulding Compositions:

The rubber solution was diluted to a solids content of 6% by addition of styrene (stabilized). After addition of 0.5 part Vulkanox HR® and 0.2 part α-methylstyrene dimer, 1,200 g of this solution were purged with N₂ in a 2 1 glass autoclave with a helical stirrer for 15 minutes. The mixture was heated up to 120° C. in the course of 1 hour and stirred (80 rpm) at this temperature for 4.5 hours. The highly viscous solution obtained was introduced into pressure-resistant moulds of aluminium and polymerized according to the following time/temperature programme:

2.5 h at 125° C.

1.5 hat 135° C.

1.5 h at 145° C.

1.5 h at 165° C.

2.5 h at 225° C.

After cooling the polymer was comminuted and degassed for 20 hours at 100° C. in vacuo. For testing, the specimens were injection moulded on an injection moulding machine. The mechanical values were determined on standard small bars.

### Example 9

The rubber solution used was that from example 6

### Example 10

The rubber solution used was that from example 7

Results

| | Example 9 | Example 10 |
|---|---|---|
| MVR [g/10′] | 13.6 | 9.2 |
| aₙ, 23° C. [kJ/m²] | 35.3 | 46.2 |
| aₙ, −40° C. [kJ/m²] | 27.2 | 39.9 |
| Tensile strength [N/mm²] | 35.1 | 34.2 |
| Elongation at break [%] | 12.5 | 45.9 |
| Yield stress [N/mm²] | 40.4 | 32.8 |
| E modulus [MPa] | 3,117 | 2,220 |

### Comparison Examples 11 and 12

Catalyst Ageing

66 ml toluene, 13.5 g butadiene, 63.8 ml of a 5.63 molar solution of DIBAH and 8 ml of a 1 molar EASC solution were added through a septum to 50 ml of a 0.245 molar solution of neodymium(III) versatate (NDV) in hexane in 200 ml Schlenk vessel at 25° C., heated at 50° C. for 2 hours, while stirring, and employed for the polymerization.

Polymerization

The polymerization was carried out in a 40 1 steel reactor with an anchor stirrer (100 rpm). A solution of DIBAH in hexane was added at room temperature to a solution of butadiene in styrene as a scavenger, the reaction solution was heated to 35° C. in the course of 10 min and the corresponding amount of catalyst solution was added. During the polymerization the reaction temperature was kept at 35° C. After the end of the reaction time the polymer solution was transferred to a second reactor (80 1 reactor, anchor stirrer, 50 rpm) in the course of 5 min and the polymerization was stopped by addition of 345 g methyl ethyl ketone with 30.4 g Irganox 1076 and 27 g Irgafos TNPP. To remove unreacted butadiene, the internal pressure of the reactor was reduced at 50° C. to 200 mbar in the course of 1 h and to 100 mbar in the course of 2h.

The batch sizes, reaction conditions and the properties of the polymer obtained are stated in table 2.

TABLE 2
(Comparison examples 11 and 12)

| Example | 11 | 12 |
|---|---|---|
| Catalyst solution in ml | 155 | 193 |
| NDV in mmol | 9.84 | 12.24 |
| Polymerization | | |
| Styrene in g | 16,915 | 21,041 |
| Water content in ppm | 47 | 26 |
| 1,3-Butadiene in g | 4,900 | 6,090 |
| DIBAIH (1.4 molar) in ml | 48.8 | 43.4 |
| Temperature in ° C. | 65 | 65 |
| Reaction time in h | 4 | 2.3 |
| Polymer | | |
| Solids content in wt. % in styrene | 22.3 | 14.3 |
| PS content in the solids content in wt. % | 9.4 | 8.0 |
| cis-BR in % in the BR content | 96.6 | 97.1 |
| trans-BR in % in the BR content | 2.5 | 2.2 |
| 1,2-BR in % in the BR content | 0.9 | 0.7 |
| η (5% in styrene) in mPa · s | 51 | 36 |
| Mn in kg/mol | n.d. | n.d. |
| Mw in kg/mol | n.d. | n.d. |

### Comparison Example 13

Semi-continuous ABS polymerization

A tank cascade of a continuously operated thoroughly mixed reactor and a thoroughly mixed reactor operated batchwise is used. The level of fill is 0.66 kg in the first stirred tank and 1.52 kg in the reactor operated batchwise. 2,530 parts by wt. of the rubber solution from example 11 are mixed together with 4,390 parts by wt. styrene and 2,255 parts by wt. acrylonitrile to form a polybutadiene stock solution.

The stock solution is fed at a rate of 0.686 kg/h into the first reactor, which is stirred with an anchor stirrer at 80 rpm. The reaction temperature is kept at 85° C. under atmospheric pressure. At the same time, 0.68 g tert-butyl pemeodecanoate as a 0.6 per cent solution in methyl ethyl ketone is metered in per hour. The level of fill is kept at 1.387 kg by discharging the polymerization syrup through a bottom outlet (average residence time 1.75 h). After three average residence times, a solids content of 27 wt. % is established, corresponding to a conversion of 27%, based on the styrene and acrylonitrile. The operating state is that after phase inversion.

After a running time of only approx. 15 h a few small white specks become visible in the reaction mixture, some of which are deposited on the stirrer. The number of specks increases constantly with time. After approx. 30 h the reactor discharge is blocked by the specks and must be cleared. After a running time of 34 h the experiment is discontinued.

1. Process for the polymerization of conjugated diolefins (dienes), characterized in that the polymerization of the diolefins is carried out in the presence of catalysts comprising
a) at least one compound of the rare earth metals,
b) at least one organoaluminium compound
c) optionally at least one modifying agent
and in the presence of vinylaromatic compounds at temperatures of −30 to +100° C., wherein the molar ratio of components (a):(b):(c) is in the range from 1:1 to 1,000:0.1 to 10, component (a) of the catalyst is employed in amounts of 1 μmol to 10 mmol per 100 g of the conjugated diolefins employed and the aromatic vinyl compound is employed in amounts of 50 to 300 parts by wt. per 100 parts by wt. of the conjugated diolefins employed, and the conversion of diolefin employed is preferably less than 50 mol %.

2. Process according to claim 1, characterized in that the conversion of diolefin employed is 10 to 45 mol %.

3. Process according to claim 1, characterized in that the conversion of diolefin employed is 20 to 40 mol %.

4. Process according to claims 1 to 3, characterized in that the conjugated diolefins are chosen from the group consisting of 1,3-butadiene, 1,3-isoprene, 2,3-dimethylbutadiene, 2,4-hexadiene, 1,3-pentadiene and/or 2-methyl-1,3-pentadiene or mixtures thereof.

5. Process according to claims 1 to 4, characterized in that the rare earth metal compounds chosen are their alcoholates, phosphonates, phosphinates, phosphates and carboxylates and the complex compounds of the rare earth metals with diketones and/or the addition compounds of halides of the rare earth metals with an oxygen or nitrogen donor compound.

6. Process according to claims 1 to 5, characterized in that component a) is chosen from neodymium versatate, neodymium octanoate or neodymium naphthenate or mixtures thereof.

7. Process according to claims 1 to 6, characterized in that organoaluminium compounds with metals chosen from group IIa, IIb and IIIb of the periodic table are employed as component (b).

8. Process according to claims 1 to 7, characterized in that the odifying agents (component c) are chosen from the groups consisting of organic halogen compounds or halogenated inorganic or organometallic compounds of group IIIb, IVb and Vb of the periodic table of the elements.

9. Process according to claims 1 to 8, characterized in that the aromatic vinyl compounds are chosen from the group consisting of styrene, α-methylstyrene, α-methylstyrene dimer, p-methylstyrene, divinylbenzene, alkylstyrenes having 2 to 6 C atoms in the alkyl radical or mixtures thereof.

10. Use of conjugated dienes obtainable according to claims 1 to 9 for the preparation of rubber-modified thermoplastic moulding compositions.

11. Process for the preparation of rubber-modified thermoplastic moulding compositions, characterized in that the polymerization of a vinylaromatic monomer or of a vinylaromatic monomer and an ethylenically unsaturated nitrile monomer is carried out in the presence of a rubber which is dissolved in the vinylaromatic monomer and is obtainable according to claims 1 to 9 by polymerization of a diolefin.
